(19) United States
(12) Patent Application Publication
(10) Pub. No.: US 2014/0022724 A1
(43) Pub. Date: Jan. 23, 2014

(54) HEAT DISSIPATION APPARATUS

(71) Applicant: Hon Hai Precision Industry Co., Ltd., New Taipei (TW)

(72) Inventors: CHIH-HANG CHAO, New Taipei (TW); WEI-CHENG CHENG, New Taipei (TW)

(21) Appl. No.: 13/911,251

(22) Filed: Jun. 6, 2013

(30) Foreign Application Priority Data
Jul. 20, 2012 (TW) 101126404

(51) Int. Cl. G06F 1/20

(52) U.S. Cl. CPC G06F 1/20
USPC 361/679.47

(57) ABSTRACT

A heat dissipation apparatus includes a motherboard has a first heat source and a second heat source thereon, a heat transmission module and a cooling fan. One terminal of the heat transmission module contacts the first heat source. The heat transmission module transmits heat from the first heat source to another terminal of the heat transmission module. The cooling fan has a first air inlet opening, a first air outlet opening and a second air outlet opening. The first air outlet opening faces the another terminal of the heat transmission module. The second air outlet opening faces the second heat source. The cooling fan rotates and generates airflow that flows from the first air outlet opening to the another terminal of the heat transmission module. The cooling fan rotates and generates airflow that flows from the second air outlet opening to the second heat source.

### BACKGROUND

1. Technical Field

The present disclosure relates to a heat dissipation apparatus for dissipating heat from multiple heat sources.

2. Description of Related Art

An All-in-One computer is a desktop computer that combine the monitor into the same case as the CPU. A typical all-in-one computer includes a motherboard, a heat sink and a cooling fan. A plurality of heat sources (e.g., CPU, north bridge chip, south bridge chip) are attached on the motherboard. The heat sink is attached on the CPU. An outlet of the cooling fan opens towards the heat sink. Thus, an airflow from the cooling fan flows through the heat sink to dissipate heat generated by the CPU. Each of the heat sources needs an individual heat sink and a cooling fan to dissipate heat. However, the heat sink and the cooling fan in the computer are both placed on the motherboard, which occupies too much space for the heat to be dissipated efficiently.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a heat dissipation apparatus, the heat dissipation apparatus comprising a heat transmission module and a fan.

FIG. 2 is an isometric view of the fan of FIG. 1.

FIG. 3 is an assembled view of the heat dissipation apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

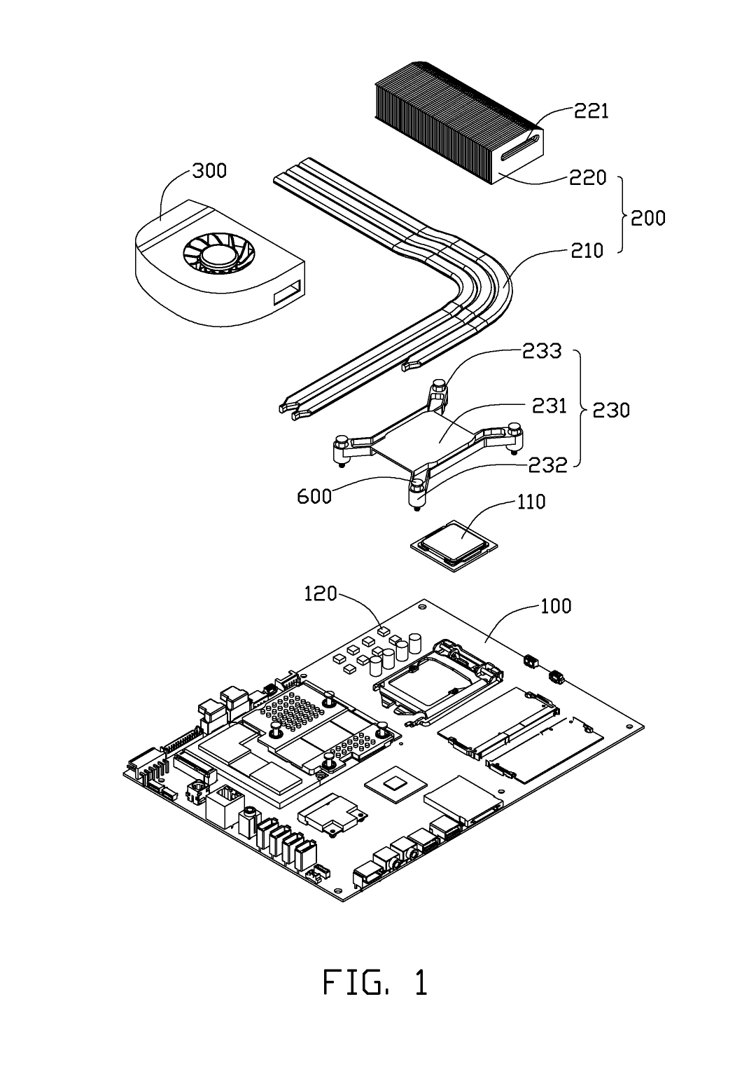

FIG. 1 shows a heat dissipation apparatus of the embodiment. The heat dissipation apparatus includes a motherboard 100, a heat transmission module 200 and a cooling fan 300.

A first heat source 110 is fixed on the motherboard 100. The heat transmission module 200 includes a plurality of heat pipes 210 and parallel fins 220. The plurality of heat pipes 210 are positioned parallel on the first heat source 110 abutting against each other. A mounting socket 230 is mounted on the plurality of heat pipes 210. The mounting socket 230 includes a body 231. Four supporting legs 232 are extended from four corners of the body 231 respectively. A mounting hole 233 is defined in each of the four supporting legs 232. The mounting socket 230 resists the first heat source 110 on the motherboard 100 by first terminals of the plurality of heat pipes 210. A mounting slot 221 is defined in each of the plurality of fins 220. A second heat source 120 is fixed on the motherboard 100 adjacent to the first heat source 110. In one embodiment, the first heat source 110 is a CPU, and the second heat source 120 includes a plurality of voltage regulating units.

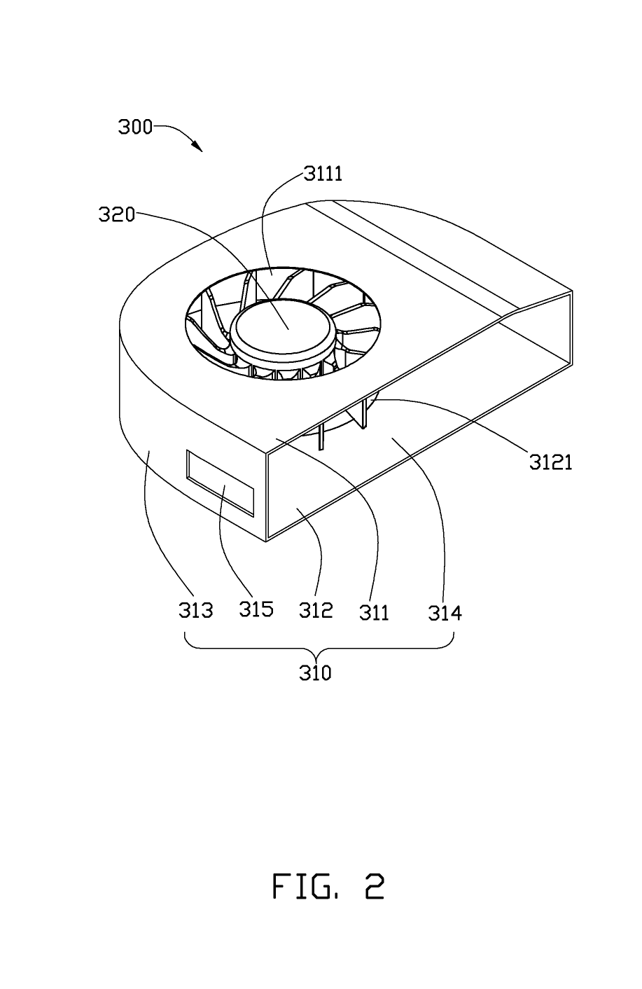

FIG. 2 shows the cooling fan 300 includes a shell 310 and a rotatable fan lade module 320 fixed in the shell 310. The shell 310 includes a top plate 311, a bottom plate 312 parallel to the top plate 311, and a connecting plate 313 connected to the top plate 311 and the bottom plate 312. A first air inlet opening 3111 is defined in the top plate 311. A second air inlet opening 3121 is defined in the bottom plate 312. The first air inlet opening 3111 and the second air inlet opening 3121 face the fan blade module 320. The top plate 311, the bottom plate 312 and the connecting plate 313 cooperatively form a first air outlet opening 314 therebetween. A second air outlet opening 315 is defined in the connecting plate 313. The first air inlet opening 3111 and the second air inlet opening 3121 allow air to flow into the cooling fan 300 along a vertical direction parallel to a rotating axis of the fan blade module 320. The first air outlet opening 314 and the second air outlet opening 315 allow air to flow out from the cooling fan 300 along a horizontal direction perpendicular to the vertical direction.

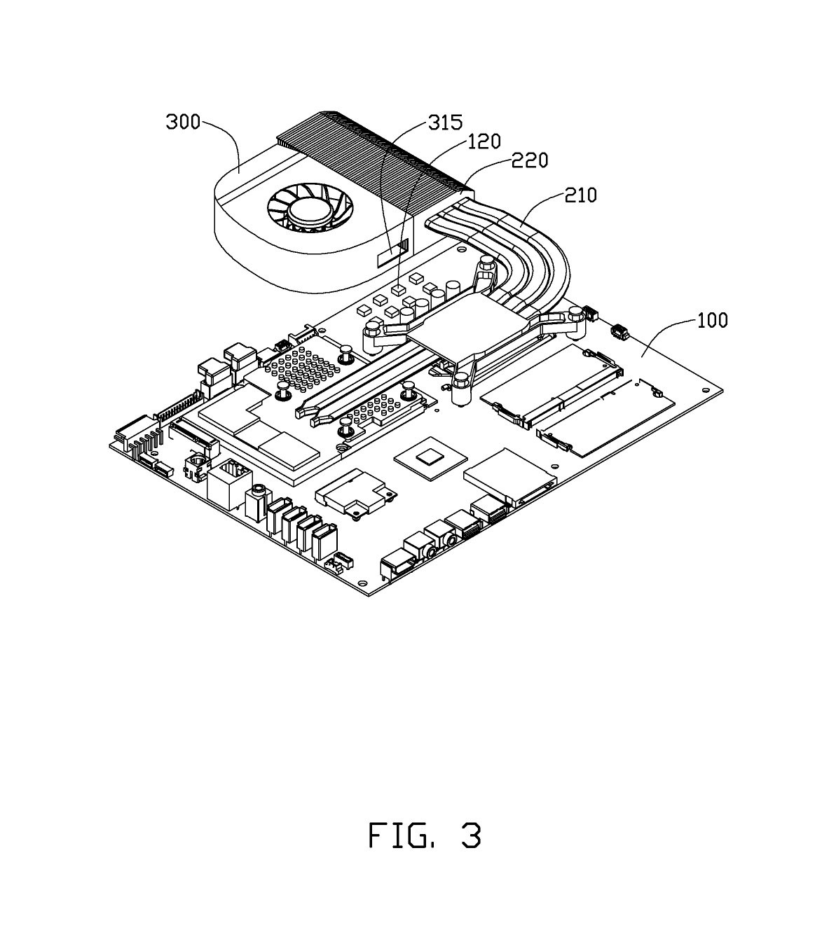

FIGS. 1 to 3 show that in assembly, the first heat source 110 is mounted on the motherboard 100. The first terminals of the plurality of heat pipes 210 are located on the first heat source 110. The mounting socket 230 abuts against the first terminals of the plurality of heat pipes 210. A plurality of fasteners 600 pass through the corresponding mounting holes 233 to fix the mounting socket 230 on the motherboard 100. Second terminals of the plurality of heat pipes 210 passes through the mounting slots 221 to fix the plurality of fins 220 on the plurality of heat pipes 210. Finally, the cooling fan 300 is located at one side of the plurality of fins 220. The first air outlet opening 314 faces the first heat source 110. The second air outlet opening 315 faces the second heat source 120. In one embodiment, the cooling fan 300 is connected with the plurality of fins 220 by gluing or by riveting.

In operation, the first heat source 110 and the second heat source 120 generate heat. The heat generated by the first heat source 110 is transmitted to the plurality of fins 220 by the plurality of heat pipes 210. The plurality of fins 220 dissipate heat generated by the first heat source 110. The fan blade module 320 rotates and generates airflow that flows from the first air outlet opening 314 to the plurality of fins 220. The fan blade module 320 rotates and generates airflow that flows from the second air outlet opening 315 to the second heat source 120. The cooling fan 300 dissipates heat for the first heat source 110 and the second heat source 120 individually via the first air outlet opening 314 and the second air outlet opening 315. Thus, a layout space can be saved as only a single heat transmission module 200 and cooling fan 300 is needed.

Using a software application called Icepak to simulate the efficiency of the heat dissipation apparatus, the following results of an embodiment shown below were obtained. The simulated conditions are set to: initial ambient temperature 35 degrees Celsius. A power dissipation of the first heat source 110 is 58.5W. A power dissipation of the second heat source 120 is 12.2W. A maximum air flow rate of the cooling fan 300 at the first air outlet opening 314 is 23.88 cubic feet per minute (cfm). A maximum static pressure of the cooling fan 300 at the first air outlet opening 314 is 0.46 inch-H₂O. A maximum air flow rate of the cooling fan 300 at the second air outlet opening 315 is 2.9 cfm. A maximum static pressure of the cooling fan 300 at the second air outlet opening 315 is 0.17 inch-H₂O. The simulation according to the set conditions shows that the maximum temperature on the second heat source 120 is 106.8 degrees Celsius when using the heat dissipation apparatus of the disclosure. The maximum temperature on the second heat source 120 is 125.5 degrees Celsius when using a common heat dissipation apparatus. The result shows that the maximum temperature on the second heat source 120 is largely decreased and heat dissipation efficiency is improved.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A heat dissipation apparatus comprising:
a motherboard; wherein the motherboard comprises a first heat source and a second heat source thereon;
a heat transmission module fixed on the motherboard; wherein a first terminal of the heat transmission module contacts the first heat source; the heat transmission module transmits heat from the first heat source to a second terminal of the heat transmission module; and
a cooling fan mounted to the heat transmission module; wherein the cooling fan comprises a first air inlet opening, a first air outlet opening and a second air outlet opening; the first air outlet opening faces the second terminal of the heat transmission module; the second air outlet opening faces the second heat source; the cooling fan rotates and generates airflow that flows from the first air outlet opening to the second terminal of the heat transmission module; and the cooling fan rotates and generates airflow that flows from the second air outlet opening to the second heat source.

2. The heat dissipation apparatus of claim 1, wherein the first air inlet opening allows air to flow into the cooling fan along a first direction parallel to a rotating axis of the cooling fan; and the first air outlet opening and the second air outlet opening allow air to flow out from the cooling fan along a second direction perpendicular to the first direction.

3. The heat dissipation apparatus of claim 1, wherein the cooling fan comprises a shell comprising a top plate, a bottom plate parallel to the top plate, and a connecting plate connected to the top plate and the bottom plate; and the first air inlet opening is defined in the top plate.

4. The heat dissipation apparatus of claim 3, wherein a second air inlet opening is defined in the bottom plate; the second air inlet opening faces the first air inlet opening; and the second air inlet opening allows air to flow into the cooling fan along the first direction parallel to the rotating axis of the fan blade module.

5. The heat dissipation apparatus of claim 4, wherein the cooling fan further comprises a rotatable fan blade module fixed in the shell; and the first air inlet opening and the second air inlet opening face the fan blade module.

6. The heat dissipation apparatus of claim 3, wherein the top plate, the bottom plate and the connecting plate cooperatively form the first air outlet opening therebetween; and the second air outlet opening is defined in the connecting plate.

7. The heat dissipation apparatus of claim 1, wherein the heat transmission module comprises a plurality of heat pipes and parallel fins; a mounting socket is mounted on the plurality of heat pipes; a mounting slot is defined in each of the plurality of fins; the mounting socket resists the first heat source on the motherboard by first terminals of the plurality of heat pipes; and second terminals of the plurality of heat pipes pass through the mounting slots.

8. The heat dissipation apparatus of claim 7, wherein the mounting socket comprises a body; four supporting legs are extended from four corners of the body respectively; a mounting hole is defined in each of the four supporting legs; and a fastener passes through the mounting hole to fix the mounting socket on the motherboard.

9. The heat dissipation apparatus of claim 7, wherein the first heat source is a CPU, the second heat source comprises a plurality of voltage regulating units; and the cooling fan is connected with the plurality of fins by gluing or by riveting.

10. A heat dissipation apparatus comprising:
a motherboard;
a first heat source fixed on the motherboard;
a second heat source fixed on the motherboard adjacent to the first heat source;
a heat transmission module fixed on the motherboard; wherein a first terminal of the heat transmission module contacts the first heat source; the heat transmission module transmits heat from the first heat source to a second terminal of the heat transmission module; and
a cooling fan mounted to the heat transmission module; wherein the cooling fan comprises a first air inlet opening, a first air outlet opening and a second air outlet opening; the first air outlet opening faces the second terminal of the heat transmission module; the second air outlet opening faces the second heat source; the cooling fan rotates and generates airflow that flows from the first air outlet opening to the second terminal of the heat transmission module; and the cooling fan rotates and generates airflow that flows from the second air outlet opening to the second heat source.

11. The heat dissipation apparatus of claim 10, wherein the first air inlet opening allows air to flow into the cooling fan along a first direction parallel to a rotating axis of the cooling fan; and the first air outlet opening and the second air outlet opening allow air to flow out from the cooling fan along a second direction perpendicular to the first direction.

12. The heat dissipation apparatus of claim 10, wherein the cooling fan comprises a shell comprising a top plate, a bottom plate parallel to the top plate, and a connecting plate connected to the top plate and the bottom plate; and the first air inlet opening is defined in the top plate.

13. The heat dissipation apparatus of claim 12, wherein a second air inlet opening is defined in the bottom plate; the second air inlet opening faces the first air inlet opening; and the second air inlet opening allows air to flow into the cooling fan along the firs direction parallel to the rotating axis of the fan blade module.

14. The heat dissipation apparatus of claim 13, wherein the cooling fan further comprises a rotatable fan blade module fixed in the shell; and the first air inlet opening and the second air inlet opening face the fan blade module.

15. The heat dissipation apparatus of claim 12, wherein the top plate, the bottom plate and the connecting plate cooperatively form the first air outlet opening therebetween; and the second air outlet opening is defined in the connecting plate.

16. The heat dissipation apparatus of claim 10, wherein the heat transmission module comprises a plurality of heat pipes and parallel fins; a mounting socket is mounted on the plurality of heat pipes; a mounting slot is defined in each of the plurality of fins; the mounting socket resists the first heat source on the motherboard by first terminals of the plurality of heat pipes; and second terminals of the plurality of heat pipes pass through the mounting slots.

17. The heat dissipation apparatus of claim 16, wherein the mounting socket comprises a body; four supporting legs are extended from four corners of the body respectively; a mounting hole is defined in each of the four supporting legs; and a fasteners passes through the mounting hole to fix the mounting socket on the motherboard.

18. The heat dissipation apparatus of claim 16, wherein the first heat source is a CPU, the second heat source comprises a plurality of voltage regulating units; and the cooling fan is connected with the plurality of fins by gluing or by riveting.
